(19) United States
(12) Patent Application Publication
(10) Pub. No.: US 2009/0033477 A1
(43) Pub. Date: Feb. 5, 2009

(54) DOOR VICINITY MONITORING SYSTEM FOR A MOTOR VEHICLE AND CORRESPONDING METHODS

(75) Inventors: Justus ILLIUM, Mainz (DE); Torsten KANNING, Eltville/Erbach (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/178,449

(22) Filed: Jul. 23, 2008

(30) Foreign Application Priority Data
Aug. 1, 2007 (DE) 102007036079.9

(51) Int. Cl. B60Q 1/00

(52) U.S. Cl. 340/436; 280/727

(57) ABSTRACT

In a method and a control device for a vehicle, it is proposed that a vicinity monitoring system monitors the immediate vicinity of the vehicle, that it is checked if a collision with possibly opening vehicle doors can occur, that the occupation of the corresponding vehicle seats is also checked, and that the corresponding door is only secured by means of warning signals or blocking in case a corresponding vehicle seat is occupied.

### CROSS-REFERENCE TO RELATED APPLICATION

This application claims priority to German Patent Application No. 102007036079.9, filed Aug. 1, 2007, which is incorporated herein by reference in its entirety.

### TECHNICAL FIELD

The present invention pertains to the field of automotive engineering, particularly to the field of safety devices for motor vehicles.

### BACKGROUND

As technical developments progress and the density of road traffic, as well as the stress while driving a motor vehicle, continues to increase, the attentiveness of the driver and of the other road traffic participants also needs to increase accordingly.

In order to provide a maximum of technical assistance in the prevention of accidents, a number of safety systems for motor vehicles have already been developed, for example, vehicle interval warning systems, speed control systems, lane departure systems, parking assistance systems and collision warning systems, as well as corresponding control devices that also intervene in the control of the vehicle, for example, by braking or providing braking assistance.

One special type of accident risk is the collision with objects or other traffic participants when the vehicle doors are opened. This essentially occurs while the vehicle is at a standstill or rolls very slowly. One particularly difficult aspect in this context can be seen in that not only the driver is able to open the doors, but also the other occupants such that a centralized control is more complicated.

A number of systems known from the state of the art serve for reducing the risks involved with opening vehicle doors. For example, DE 41 19 579 A1 discloses a device for detecting objects in the vicinity of a vehicle, in which a distance measuring device that is based, for example, on ultrasound, infrared or radar is installed in the door rabbet of a vehicle door. The device is activated when the vehicle door is opened, for example, by means of a door contact switch. When the door is sufficiently opened, it is possible, for example, to detect an approaching bicyclist and a door brake can be activated in order to block the door.

EP 1 375 267 A2 discloses a system, in which a corresponding collision risk can be detected while the vehicle door is still closed. For example, a trajectory of an object is determined by means of sensors and compared with the pivoting range of a vehicle door in order to determine the collision risk. The sensor arrangement used consists of a sensor system that is already utilized for other devices of the vehicle, for example, a vehicle interval warning system or a parking assistance system.

EP 1 265 772 B1 discloses a monitoring system for a vehicle, in which a vehicle door is blocked or decelerated depending on the vicinity that is monitored by sensors. The detection of an object or a person representing a collision risk is realized by means of ultrasonic sensors, microwaves, video, infrared triangulation or similar methods. The driving situation such as, for example, the speed of the vehicle is taken into account in the output of an optical or acoustical warning signal such that the system is deactivated, for example, at high vehicle speeds. The safety device can be activated by actuating an inside door handle.

DE 10 2005 014 581 A1 discloses a method, in which the vicinity of the vehicle is monitored and a warning signal is output when an obstacle approaches. The intention to open a door of the vehicle is deduced from the signal of a proximity sensor that detects a hand approaching an inside door handle of the vehicle before actual contact is made. The warning signal can be output, for example, in haptic form by means of a door handle vibration. In addition, the door can be locked or decelerated.

DE 10 2004 049 054 A1 discloses an accident warning device for a vehicle, in which obstacles within the pivoting range of a vehicle door are detected by an obstacle warning device and a warning is output, for example, in the form of a vibration of a door operating device or a haptically perceivable change of the operating characteristic.

Consequently, known systems for reducing the risk when opening vehicle doors essentially serve for monitoring the vicinity of the vehicle and for detecting the actuation of vehicle doors or the corresponding intention, respectively.

In view of the foregoing, at least one object is to improve systems of this type in such a way that the safety against errors and failures is improved and, in particular, the vehicle doors that are subject to a collision risk can be determined even more reliably and also prevent or minimize collision with objects or other traffic participants when the vehicle doors are opened while the vehicle is at a standstill or rolls very slowly. In addition, other objects, desirable features, and characteristics will become apparent from the subsequent summary and detailed description, and the appended claims, taken in conjunction with the accompanying drawings and this background.

### SUMMARY

In accordance with one or more exemplary embodiments, the at least one object, other objects, desirable features, and characteristics are provided with a door vicinity monitoring system door collision for a motor vehicle having a that monitors a detection area in the vicinity of the vehicle by means of sensors. A collision risk with an at least partially opened vehicle door causes the safety device to output a warning signal and/or to block or decelerate the opening of the door if it is attempted to open this door. A seat monitoring system monitors which seats of the vehicle are occupied, and in that the output of a warning signal and/or the effect of the safety device on a motor vehicle door or operating elements assigned thereto depend on the data that is assigned to the respective motor vehicle door and determined by the seat monitoring system.

The invention is based on the notion that the monitoring of doors situated adjacent to unoccupied vehicle seats can, in principle, be eliminated in order to prevent false alarms. The monitoring rather should be focused on the fact that the collision risk is lower for vehicle doors that are situated directly adjacent to vehicles seats occupied by an occupant. These doors are subject to the risk of being opened by the occupant or the driver without prior circumspection such that a collision with standing or moving obstacles, vehicles or pedestrians may occur.

To this end, a seat monitoring system is provided that determines which seats of the vehicle are occupied, for example, by monitoring the weight by means of sensors in the seat or an optical monitoring system, for example, with a camera or a light barrier system or another conventional type of monitoring system such as, for example, infrared or the like. If a vehicle seat is occupied, the safety device on the door situated adjacent to this vehicle seat is activated or the safety device is enabled to act upon this door. The corresponding assignment of the doors to the vehicle seats may be realized, for example, such that the passenger seat is assigned to the right front door, the right rear seat is assigned to the right rear vehicle door, the left rear seat is assigned to the left rear vehicle door and the center seat of the rear bench seat is respectively assigned to both rear vehicle doors because a person who sits in this seat could, in principle, operate both rear vehicle doors.

If a corresponding collision risk with an object or another traffic participant is detected and an occupant is seated at the corresponding door, the warning signals are output at least in instances, in which a door opening process is initiated or imminent.

The invention can be advantageously realized such that the seat monitoring system not only monitors the, to which the seats are subjected, but also determines the weight distribution, for example, in order to distinguish a sitting occupant from a dead load such as, for example, a shopping bag. To this end, several weight sensors may be installed in a seat in order to distinguish a person from a bag or a box based on the weight distribution.

In addition, it would also be possible to monitor a seat with respect to changes of the weight distribution that are more typical for a living occupant than for goods to be transported.

Corresponding warning signals can already be output when a hand of an occupant or the driver approaches a corresponding operating element for opening the door, for example, a door lever or an electric unlock button. This can be realized by means of proximity switches. However, it would also be possible, in principle, to couple the safety device with the actual actuation of a door opener.

The inventive vicinity monitoring system of the vehicle may consist, for example, of a conventional vehicle interval warning system or a parking assistant with corresponding ultrasonic sensors, lidar sensors or radar sensors that carry out distance measurements to the front, rear or lateral areas of the vehicle or of an electronic camera, the images of which are analyzed with respect to approaching objects by means of a data processing device. This not only makes it possible to determine the collision risk in a summary fashion, but also individually for each vehicle door.

To this end, it is also possible to determine one respective trajectory of an obstacle approaching the vehicle—referred to a relative movement—for example, an approaching bicycle or an access restriction post that approaches while parking slowly. This trajectory is compared with the pivoting range of each vehicle door to be monitored and the collision risk is determined thereof.

In order to warn the corresponding vehicle occupant before the door is opened, it is possible to output an optical and/or acoustical and/or haptical signal, wherein a vibration of a door lever, a door opening button or a corresponding remote control is particularly advantageous in this respect.

In addition, the opening of the door can also be blocked or delayed, for example, by decelerating the door such that it is more difficult to open or by unlocking the door in a time-delayed fashion. This prevents the door from being opened by the vehicle occupant quasi automatically despite the output of a warning signal before the occupant registers the warning signal.

In addition to an apparatus and corresponding method of the above-described type, the embodiments of the invention also pertains to a control device for a motor vehicle with a vicinity monitoring system for detecting objects in the vicinity of the vehicle, as well as a safety device that, if applicable, outputs a warning signal and/or blocks or decelerates the opening of a door.

The method and apparatus for preventing accidents and minimizing risks utilizes a vicinity monitoring system for a vehicle that is coupled with a corresponding safety device for outputting a warning signal, as well as with a seat monitoring system, in order to only monitor the doors at risk and to respectively output a corresponding warning signal and block or decelerate the respective door if an occupant or the driver opens or attempts to open this door.

### BRIEF DESCRIPTION OF THE DRAWINGS

The present invention will hereinafter be described in conjunction with the following drawing figures, wherein like numerals denote like elements, and

FIG. 1 shows a top view of a vehicle in a traffic situation;

FIG. 2 shows the interaction between the different sensor and safety devices of the vehicle;

FIG. 3 shows a schematic illustration of the method;

FIG. 4 shows a schematic illustration of the inner side of a vehicle door; and

FIG. 5 shows a sensor system for a vehicle seat.

### DETAILED DESCRIPTION

The following detailed description is merely exemplary in nature and is not intended to limit the invention or the application and uses. Furthermore, there is no intention to be bound by any theory presented in the preceding summary and background or the following detailed description.

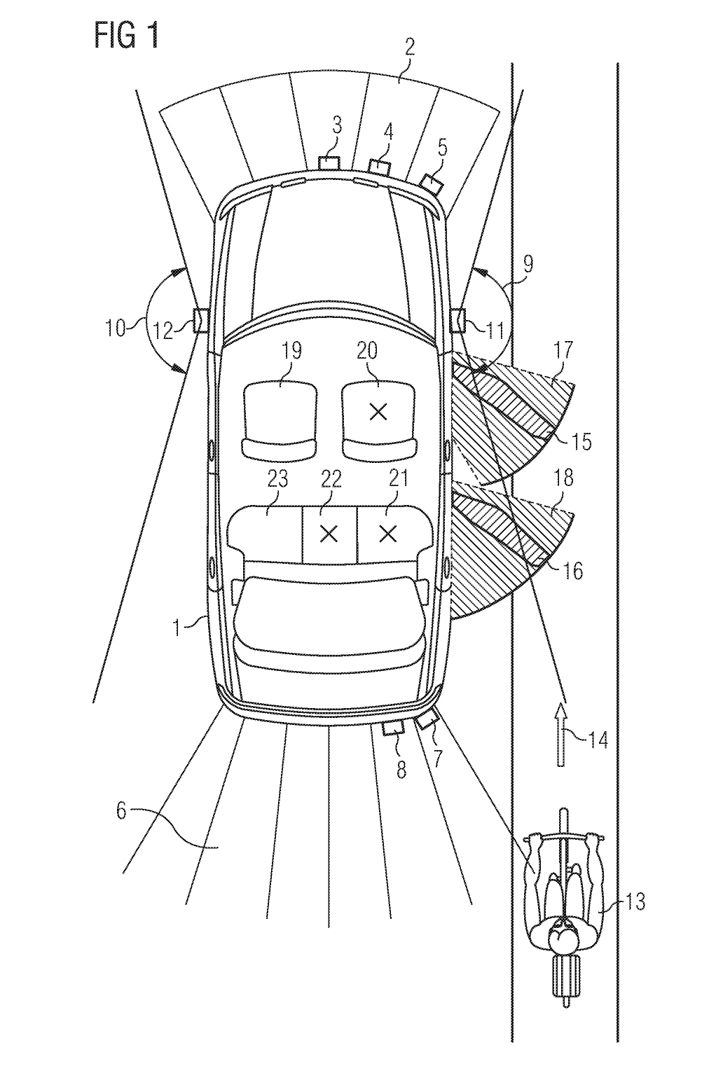

FIG. 1 shows a schematic top view of a vehicle 1 with a vicinity monitoring system for respectively monitoring selective regions of the vehicle vicinity, namely by means of ultrasonic sensors 3, 4, 5 in a front detection area 2, ultrasonic sensors 7, 8 in a rear detection area 6 and cameras 11, 12 in lateral detection areas 9, 10 situated to the right and the left of the vehicle referred to the driving direction. These sensors 3, 4, 5, 7, 8, 11, 12 basically measure distances to obstacles or other traffic participants and respectively register changes or record and electronically analyze images of the vicinity. This makes it possible to detect obstacles 13, such as, a bicyclist in the respective position, for example, with the right rear ultrasonic sensor 7. The changes in the relative position between the vehicle 1 and the obstacle 13 during the course of a movement of the vehicle 1 or the obstacle 13 can also be detected. This makes it possible, for example, to calculate a trajectory 14 of the obstacle relative to the vehicle.

The vehicle features four vehicle doors, the right doors 15, 16 of which are illustrated in a partially opened position and highlighted with a hatching. A pivoting range 17, 18 of the respective door, in which a collision with objects may occur when the door is opened, is also respectively illustrated with a hatching. The respective pivoting range 17, 18 can now be compared with the current position of an obstacle 13 or the calculated trajectory thereof in order to determine if a collision is imminent. In addition to vehicle doors 15, 16, it would be possible to also monitor, for example, a rear hatch that is not illustrated in the figures because this hatch can also be pivoted into a collision area. In order to prevent false alarms and, if possible, to only monitor the doors 15, 16 at risk, the occupation of the vehicle seats 19, 20, 21, 22, 23 is also monitored. For example, if only the seats 19, 23 are occupied, a bicyclist 13 does not represent a collision risk because it is highly improbable that the doors 15, 16 are opened by the corresponding occupants.

In the illustrated instance, the seats 20, 21, 22 are occupied, for example, while the vehicle is parked and the driver has briefly left the vehicle. It is therefore quite possible that one of the occupants occupying the seats 20, 21 opens one of the doors 15, 16. It should be generally noted that, as described above, the vicinity monitoring system is already provided in many vehicles for the purpose of parking assistance or parking spot identification, and that only software changes and supplements are required in order to utilize the corresponding vicinity monitoring for the inventive method.

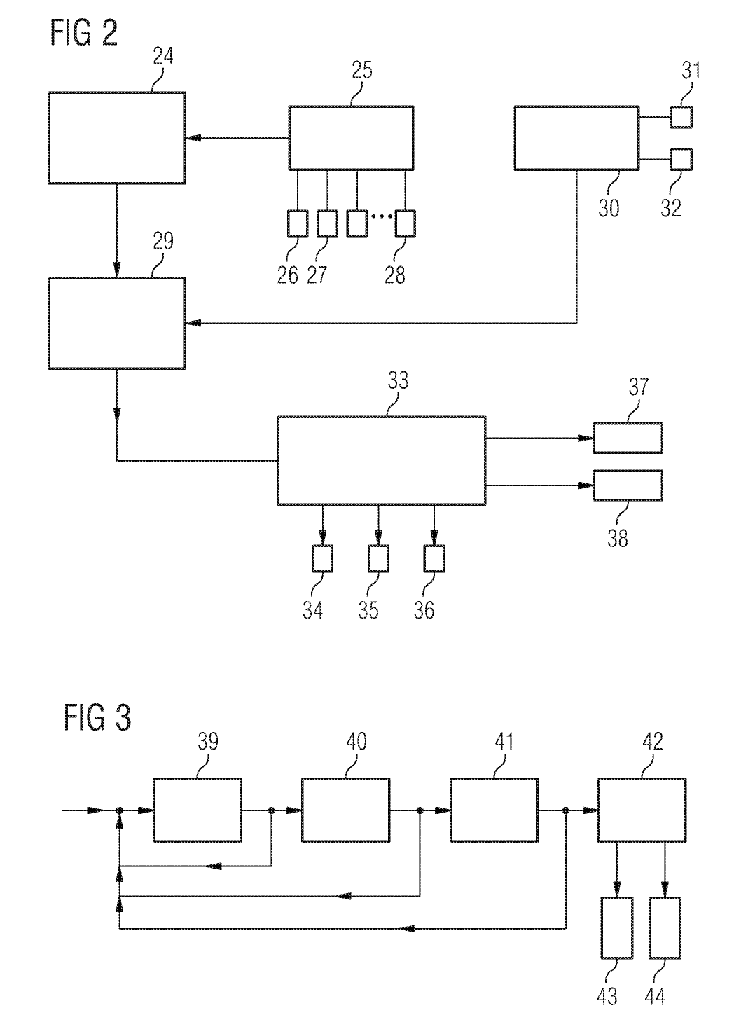

A system for monitoring the use of seats is also frequently provided for safety reasons, for example, in order to supplement corresponding safety belt systems and to operate belt pre-tensioning devices. FIG. 2 shows how the different systems of the vehicle interact. The reference symbol 24 identifies the vicinity monitoring system, into which the corresponding above-described sensors and the pre-processing device are integrated. The vicinity monitoring system receives information from the seat monitoring system 25 that is connected to the sensors 26, 27, 28. These sensors may consist, for example, of weight sensors that are distributed over the seat surface.

Corresponding pre-processing makes it possible to determine if the respective seat is subjected to a weight and if this weight is caused, for example, by a shopping bag or by an occupant. This provides the central computer 29 with information on the doors that are subject to a collision risk in case an obstacle is detected (e.g., the doors that are specially monitored).

In addition, an opening detection device 30 that is connected to the door lever 31 and/or another operating element 32 such as, for example, a remote control or an opening or unlock button detects if one of the vehicle occupants intends to open a certain vehicle door. This information is transmitted to the central computer 29 that links and subsequently transmits the corresponding information to a safety device 33. This safety device is able to optionally output warning signals by means of an optical device 34, an acoustical device 35 or a haptical device 36, for example, a vibrator, and to optionally trigger a door blocking device 37 or a door decelerating device 38, respectively, at the same time.

This not only warns the corresponding vehicle occupant to refrain from opening the door, but also makes it at least more difficult to open the door if it is not completely blocked.

FIG. 3 basically shows a method according an embodiment with the corresponding steps. In a first step 39, the vicinity of the vehicle is monitored for obstacles. This step is repeated until an obstacle is detected.

In a second step 40, the corresponding trajectory is calculated and respectively compared with the pivoting ranges of the doors that can be opened. If it is determined that a collision is possible, the next step 41 is initiated in order to determine the occupation status of a seat situated adjacent to a door that is subject to the collision risk. If this is not the case, the method is repeated from the beginning. If the corresponding seat is occupied, a preventive measure 42 is initiated by means of the safety device in the next step, namely parallel or alternatively by means of a step 43, in which warning signals are output, and a step 44, in which the corresponding vehicle door is blocked and/or decelerated.

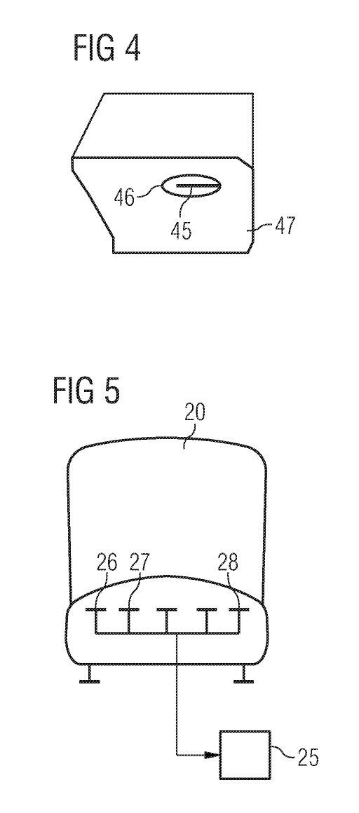

FIG. 4 shows a detailed interior view of a vehicle door, wherein it is possible to output a warning by vibrating the door handle 45, the door handle shell 46 or the complete inside paneling 47.

For reasons of completeness, FIG. 5 shows a sectioned vehicle seat 20 with weight sensors 26, 27, 28 that detect a weight on a seat and send corresponding measuring signals to the pre-processing unit. This unit is able to basically determine how the weight is distributed and can also interpret possible changes of the weight distribution.

It can therefore be summarized that the method and the corresponding control device make it possible to lower the collision risk when opening vehicle doors, wherein the risk of false alarms can also be largely precluded.

While at least one exemplary embodiment has been presented in the foregoing detailed description, it should be appreciated that a vast number of variations exist. It should also be appreciated that the exemplary embodiment or exemplary embodiments are only examples, and are not intended to limit scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An apparatus for minimizing collision of a motor vehicle door with an object, comprising:
a vicinity monitoring system adapted to identify the object in a detection area within a vicinity of the motor vehicle door;
a collision risk calculator adapted to compare a trajectory of the object with a pivoting range of the motor vehicle door to determine a collision risk if the object is identified in the detection area with the vicinity of the motor vehicle door;
a seat monitoring system adapted to monitor a seat associated with the motor vehicle door and determine an occupant status of the seat; and
a safety device adapted to initiate a preventative measure if an attempt is made to open the motor vehicle door, the collision risk exists, and the occupant status of the seat indicates the seat is occupied.

2. The apparatus according to claim 1, wherein the seat monitoring system monitors weight to determine the occupant status of the seat.

3. The apparatus according to claim 1, wherein the seat monitoring system monitors weight distribution to determine the occupant status of the seat.

4. The apparatus according to claim 1, wherein the seat monitoring system monitors changes in a weight distribution to determine the occupant status of the seat.

5. The apparatus according to claim 1, wherein the vicinity monitoring system utilizes ultrasound.

6. The apparatus according to claim 1, wherein the vicinity monitoring system utilizes a camera.

7. The apparatus according to claim 1, wherein the preventative measure comprises vibration of the motor vehicle door.

8. The apparatus according to claim 1, wherein preventative measure comprises deceleration of the motor vehicle door.

9. The apparatus according to claim 1, wherein the preventative measure comprises an acoustical warning signal.

10. A method for minimizing collision of a motor vehicle door with an object, comprising the steps of:
monitoring the vicinity of the motor vehicle door for a presence of the object until detecting the object;
calculating a corresponding trajectory of the object;
comparing the corresponding trajectory of the object with a pivoting range for the motor vehicle door to determine if a collision possibility exists;
determining an occupant status of a seat associated with the motor vehicle door to determine if the collision possibility exists; and
initiating a preventative measure to at least inhibit movement of the motor vehicle door if the occupant status of the seat indicates the seat is occupied.

11. The method according to claim 10, wherein the seat monitoring system monitors weight to determine the occupant status of the seat.

12. The method according to claim 10, wherein the seat monitoring system monitors weight distribution to determine the occupant status of the seat.

13. The method according to claim 10, wherein the seat monitoring system monitors changes in a weight distribution to determine the occupant status of the seat.

14. The method according to claim 10, wherein the vicinity monitoring system utilizes ultrasound.

15. The method according to claim 10, wherein the vicinity monitoring system utilizes a camera.

16. The method according to claim 10, wherein the preventative measure comprises vibration of the motor vehicle door.

17. The method according to claim 10, wherein preventative measure comprises deceleration of the motor vehicle door.

18. The method according to claim 10, wherein the preventative measure comprises an acoustical warning signal.
